(19) United States
(12) Patent Application Publication
(10) Pub. No.: US 2026/0075066 A1
(43) Pub. Date: Mar. 12, 2026

(54) SYSTEM AND METHOD FOR INTELLIGENTLY DETECTING AND LOCATING ROGUE ONU DEVICE

(71) Applicant: Chunghwa Telecom Co., Ltd., Taoyuan City (TW)

(72) Inventors: Ping-Chang Tsai, Taoyuan City (TW); Shun-Kai Yang, Taoyuan City (TW); Lung-Chin Huang, Taoyuan City (TW); Chun-Kuei Chen, Taoyuan City (TW); Fei-Hua Kuo, Taoyuan City (TW)

(73) Assignee: Chunghwa Telecom Co., Ltd., Taoyuan City (TW)

(21) Appl. No.: 18/939,531

(22) Filed: Nov. 7, 2024

(30) Foreign Application Priority Data
Sep. 6, 2024 (TW) 113133958

(51) Int. Cl. H04L 9/40; H04L 43/04

(52) U.S. Cl. CPC H04L 63/1416; H04L 43/04; H04L 63/1441

(57) ABSTRACT

A system and a method for intelligently detecting and locating a rogue ONU device. The system includes multiple ONU devices, an OLT device, a database and an intelligent rogue device monitoring equipment. The OLT device distributes optical signals to the ONU devices through an optical splitter. The intelligent rogue device monitoring equipment is electrically connected to the OLT device and the database respectively. The intelligent rogue device monitoring equipment periodically collects alarm messages from the OLT device, stores the alarm messages in the database, determines whether the OLT device is abnormal according to the alarm messages, and identifies the rogue ONU device among the ONU devices according to the alarm messages and alarm rules.

### CROSS-REFERENCE TO RELATED APPLICATION

This application claims the priority benefit of Taiwan application serial no. 113133958, filed on Sep. 6, 2024. The entirety of the above-mentioned patent application is hereby incorporated by reference herein and made a part of this specification.

### BACKGROUND

### Technical Field

The disclosure relates to detecting and locating a rogue ONU device, and in particular to a system and a method for intelligently detecting and locating a rogue ONU device.

### Description of Related Art

As the coverage rate of fiber optic networks significantly increases, the number of passive optical networks (PON) in use worldwide has gradually risen to the billions.

The PON technical system is a time-division multiplexing system with a point-to-multiple-point (P2MP) architecture. One optical line terminal (OLT) device can accommodate multiple optical network unit (ONU) devices to provide fiber optic internet services to many users. Since the uplink light emission times of each ONU device are allocated in time slots by the OLT device, if an ONU device emits light outside of the time slots scheduled by the OLT device, the uplink signals of other ONU devices will be affected. This further causes network disruption for a large number of users, which is defined as a rogue malfunction. Rogue malfunctions are a challenging issue for telecommunications operators in terms of providing stable services to users.

As shown in the schematic diagram of the conventional rogue phenomenon in FIG. 1, rogue issues arise in more than just one scenario. In general, they can be divided into two types: long light emission and random light emission. A rogue ONU2 or a rogue ONU N emits light outside of the time slots scheduled by the OLT device, affecting the uplink signals of other ONU devices under the same PON port, resulting in rogue phenomena. When rogue phenomena occur, the system equipment will generate alarm signals. False light emission by rogue ONU devices can affect the network services of some or most of the normal ONU users under the same PON port. Conventional methods of handling rogue malfunctions involve disconnecting optical fibers to perform offline searches to identify the malfunction or rogue ONU devices, which often requires a large amount of time and labor costs to locate the malfunction or rogue ONU devices.

### SUMMARY

The disclosure provides a system and method for intelligently detecting and locating rogue ONU devices. It effectively reduces the time and labor costs for troubleshooting without affecting the network services of normal users, thereby further improving network service stability.

The system for intelligently detecting and locating rogue optical network unit (ONU) devices of the disclosure includes multiple ONU devices, an optical line terminal (OLT) device, a database, and an intelligent rogue device monitoring equipment. The OLT device distributes optical signals to the ONU devices through an optical splitter. The intelligent rogue device monitoring equipment is electrically connected to the OLT device and the database, respectively. The intelligent rogue device monitoring equipment periodically collects alarm messages from the OLT device according to a preset detection time cycle, stores the alarm messages in the database, determines whether the OLT device is abnormal according to the alarm messages, and identifies the rogue ONU device among the ONU devices according to the alarm messages and alarm rules.

The method for intelligently detecting and locating rogue optical network unit (ONU) devices of the disclosure is applied to a system that includes multiple ONU devices, an optical line terminal (OLT) device that distributes optical signals to the ONU devices through an optical splitter, a database, and an intelligent rogue device monitoring equipment electrically connected to both the OLT device and the database. The method comprises: the intelligent rogue device monitoring equipment periodically collecting alarm messages from the OLT device according to a preset detection time cycle and storing the alarm messages in the database; the intelligent rogue device monitoring equipment determining whether the OLT device is abnormal according to the alarm messages; and the intelligent rogue device monitoring equipment identifying the rogue ONU device among the ONU devices according to the alarm messages and alarm rules.

Based on the above, the disclosure provides a system and method for intelligently detecting and locating rogue ONU devices. It is applicable to ITU-T standard technologies such as GPON, XGSPON, 50GPON, 25G PON MSA, and future higher-speed PON systems. With remote network management and monitoring capabilities, the system can analyze and make real-time judgments according to background traffic data without affecting the network services of normal users. It also schedules and stores alarm information to prevent the possibility of overwriting or losing information due to insufficient storage capacity on the OLT device from large volumes of alarm messages. This system effectively reduces troubleshooting time and labor costs, further improving network service stability.

To make the features and advantages of the disclosure more comprehensible, several embodiments accompanied with drawings are described in detail as follows.

### BRIEF DESCRIPTION OF THE DRAWINGS

FIG. 1 is a schematic diagram of the known rogue phenomenon.

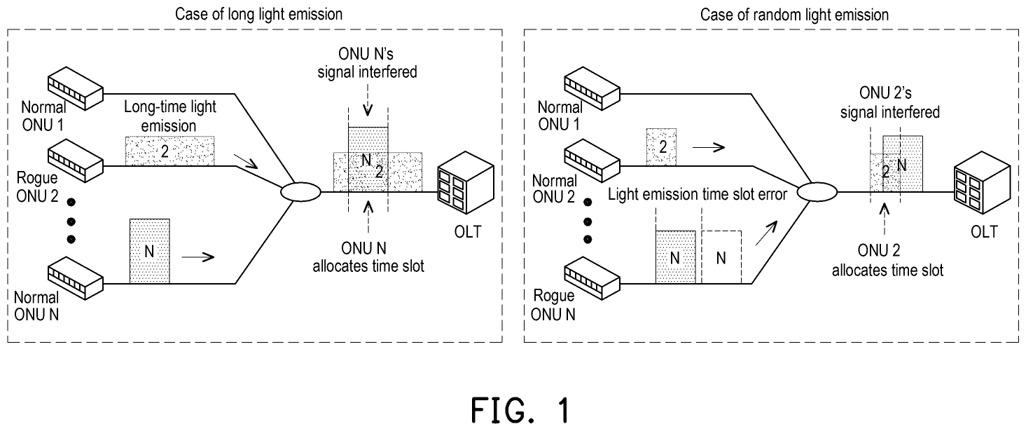

FIG. 2 is a schematic diagram of the system for intelligently detecting and locating rogue ONU devices according to a first embodiment of the disclosure.

FIG. 3 is a schematic diagram of the system for intelligently detecting and locating rogue ONU devices according to a second embodiment of the disclosure.

FIG. 4 is a flowchart of the method for intelligently detecting and locating rogue ONU devices according to an embodiment of the disclosure.

FIG. 5 is a schematic diagram of the system's operation for intelligently detecting and locating rogue ONU devices according to an embodiment of the disclosure.

### DESCRIPTION OF THE EMBODIMENTS

Some embodiments of the disclosure will now be described in detail with reference to the accompanying drawings. The component symbols used in the following description, when appearing in different figures with the same symbols, are considered to refer to the same or similar components. These embodiments represent only a portion of the disclosure and do not reveal all possible implementations of the disclosure.

The ordinal numbers used in the specification and the patent claims, such as “first,” “second,” etc., are used to modify components and do not imply any particular sequence or numerical order of the components, nor do they indicate a sequence or order in terms of manufacturing. The use of such ordinal numbers is merely to distinguish one component from another with the same name. The terms used in the claims may differ from those used in the specification. For example, a “first component” in the specification may be referred to as a “second component” in the claims. It should be understood that the features of the embodiments described below can be replaced, rearranged, or combined to create other embodiments without departing from the spirit of the disclosure.

A system for intelligently detecting and locating rogue ONU devices of the disclosure is applicable to ITU-T standard technologies such as GPON, XGSPON, 50GPON, 25G PON MSA, or future higher-speed PON systems. The architecture and operation of the system for intelligently detecting and locating rogue ONU devices will be specifically described by combining the first and second embodiments.

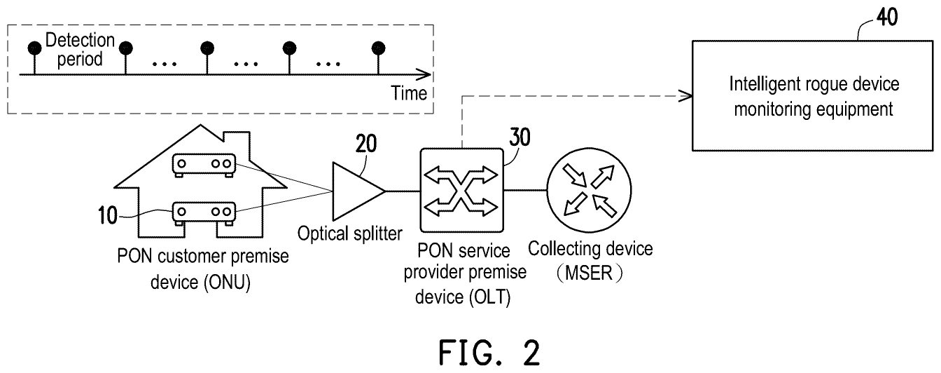

FIG. 2 is a schematic diagram of the system for intelligently detecting and locating rogue ONU devices according to the first embodiment of the disclosure.

Referring to FIG. 2, in the first embodiment, a PON service provider premise device (optical line terminal, OLT) 30 accommodates multiple PON customer premise devices (optical network unit, ONU) 10 through an optical splitter 20. The monitoring equipment (MSER) collects alarm messages from the PON service provider premise device (OLT) 30 and the PON customer premise devices (ONU) 10. An intelligent rogue device monitoring equipment 40 detects rogue phenomena on the PON port according to the alarm messages and further locates the rogue or malfunctioning PON customer premise devices (ONU) 10, allowing for the quick resolution of malfunction phenomena.

When a rogue ONU device is detected on a PON port or the PON service provider premise device (OLT) 30, the light emission time of the rogue ONU device will affect other normal ONU devices under the same PON port or PON service provider premise device (OLT) 30. Due to the reduced signal quality between the devices, alarm messages as described in the ITU-T PON technical standard documents will be generated, as shown in Table 1. The system for intelligently detecting and locating rogue ONU devices detects rogue phenomena on the PON port by utilizing the number of alarm messages (SD and SF) issued by the ONU devices and the predetermined number alarm threshold.

When rogue phenomena occur on the PON port, it indicates that at least one ONU device (including the rogue ONU device) has been disconnected from the network service of the PON service provider premise device (OLT) 30. By using the alarm times and alarm frequencies of LOSi and LOFi in the alarm messages, the ONU device that raised the earliest alarm and has the highest number of alarms can be recorded in the rogue ONU device list. Simultaneously, by collecting information from the alarm messages, such as Dying Gasp, ONU Management and Control Interface (OMCI) signaling failures, and connection authentication failures, the ONU device with the highest number of alarms can be further located from the list to assist in pinpointing the rogue ONU device. Thereafter, alarm information is generated, and the number of the rogue ONU device that needs to be addressed is notified.

In an embodiment, the alarm messages may, for example, be covered by the technical standards documents of the ITU-T PON G.98x and G.980x series. In another embodiment, the alarm messages may be, for example, communication errors in OMCI signaling between the access devices, which are also clearly defined to support the OMCI failure reporting mechanism in the ITU-T PON G.988 technical standard document. Some of the alarm messages are shown in Table 1, but the disclosure is not limited to them.

Table 1 is as follows:

| | Name of Alarm | | Name of Alarm |
|---|---|---|---|
| Abbreviation | Message | Abbreviation | Message |
| SD₍ᵢ₎ | Signal degraded | LOF₍ᵢ₎ | Loss of frame |
| | (of ONUi) | | (of ONUi) |
| SF₍ᵢ₎ | Signal fail | DG₍ᵢ₎ | Receive dying gasp |
| | (of ONUi) | | (of ONUi) |
| LOS₍ᵢ₎ | Loss of signal | RDI₍ᵢ₎ | Remote defect |
| | (of ONUi) | | Indication (of ONUi) |

In Table 1, i represents the number of the ONU device. For example, SD₍ᵢ₎ or SDᵢ can refer to the alarm message issued by the i-th ONU device or the ONU device numbered i.

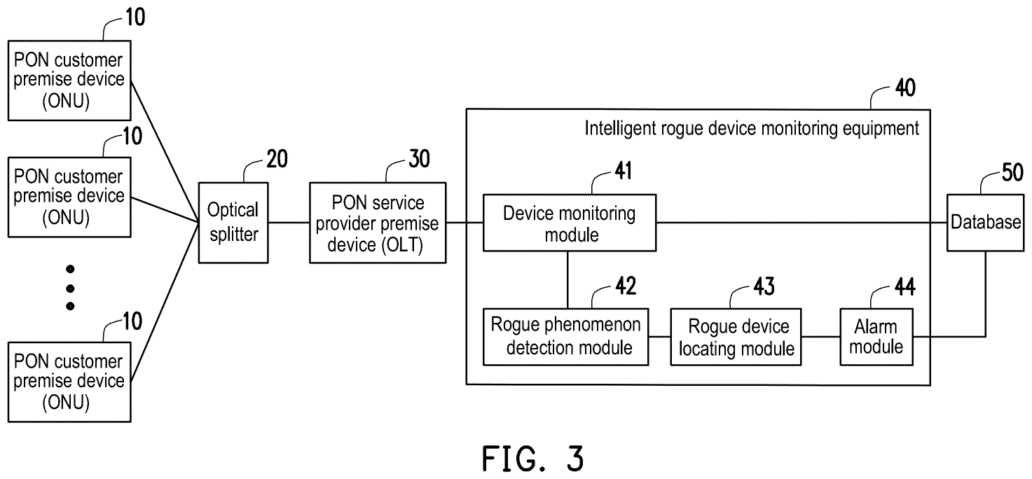

FIG. 3 is a schematic diagram of the system for intelligently detecting and locating rogue ONU devices according to the second embodiment of the disclosure.

Referring to FIG. 3, in the second embodiment, the system for intelligently detecting and locating rogue ONU devices includes multiple PON customer premise devices 10 (i.e., ONU devices 10, which will be referred to as ONU devices 10 hereafter), PON service provider premise device 30 (i.e., OLT device, which will be referred to as OLT device 30 hereafter), a database 50, and intelligent rogue device monitoring equipment 40. The OLT device 30 distributes optical signals to multiple ONU devices 10 through an optical splitter 20. The intelligent rogue device monitoring equipment 40 is electrically connected to both the OLT device 30 and the database 50.

The intelligent rogue device monitoring equipment 40 can include an device monitoring module 41, a rogue phenomenon detection module 42, a rogue device locating module 43, and an alarm module 44.

The device monitoring module 41 is electrically connected to both the OLT device 30 and the database 50. It is used to periodically collect alarm messages from the OLT device 30 and the ONU devices 10 according to a preset detection time cycle and store the alarm messages in the database 50.

In an embodiment, the detection time cycle can be set to one hour. The device monitoring module 41 can continuously collect alarm messages from the OLT device 30 and the ONU devices 10 during the detection time cycle, and store the alarm messages in the database 50 according to the schedule. In this way, it prevents the possibility of alarm information being overwritten or lost due to insufficient memory capacity in the OLT device 30.

The rogue phenomenon detection module 42 is electrically connected to the device monitoring module 41 and can determine whether the OLT device 30 is unable to handle traffic according to the alarm messages. If the OLT device 30 is unable to handle traffic, it can be determined that the OLT device 30 is abnormal. If the OLT device 30 is able to handle traffic, the rogue phenomenon detection module 42 can determine whether the OLT device 30 is abnormal by checking if the number of ONU devices 10 issuing specific alarm messages exceeds a set alarm threshold.

In an embodiment, the rogue phenomenon detection module 42 can determine whether the OLT device 30 is unable to handle traffic according to whether there is a LOS alarm message from the PON port or OLT device 30.

In an embodiment, the specific alarm messages can be SD₍ᵢ₎ and SF₍ᵢ₎. According to the total number of ONU devices 10 under the same PON port or OLT device 30, the alarm threshold can be set according to a selected ratio (e.g., 30% of the total number). The number of ONU devices 10 issuing alarm messages SD₍ᵢ₎ and SF₍ᵢ₎ is then counted. The rogue phenomenon detection module 42 can determine whether the OLT device 30 is abnormal by checking if this number exceeds the alarm threshold. In other words, it can detect whether rogue phenomena are occurring under this PON port and obtain the number of the OLT device 30 to issue a preemptive warning of a malfunction.

The rogue device locating module 43 is electrically connected to the rogue phenomenon detection module 42 and is used to identify the rogue ONU device among the ONU devices 10 according to the alarm occurrence times and the number of alarms in the alarm messages, and to record the rogue ONU device in a rogue ONU device list.

In an embodiment, the rogue device locating module 43 can identify the rogue ONU device by analyzing the alarm messages, such as LOS₍ᵢ₎ and LOF₍ᵢ₎, collected during the detection time cycle. The ONU device 10 with the earliest alarm occurrence time and the highest number of alarms is identified as the rogue ONU device, and the number of the ONU device 10 is recorded in the rogue ONU device list.

The rogue device locating module 43 can assist in identifying the rogue ONU device among the ONU devices according to the alarm messages and alarm rules.

In an embodiment, the rogue device locating module 43 can assist in locating the rogue ONU device by collecting alarm messages such as Dying Gasp, OMCI signaling failures, and connection authentication failures, and counting the ONU device 10 with the highest number of alarms, using the alarm rules as guidance.

After locating the rogue ONU device under the PON port, a report can be generated to record the reasons why the rogue ONU device matches the alarm rules for user reference. Additionally, the rogue device locating module 43 can obtain a priority processing value corresponding to the rogue ONU device according to the weight of each alarm rule and the alarm messages, and store the priority processing value in the database 50.

The alarm module 44 is electrically connected to both the rogue device locating module 43 and the database 50. It can determine whether to issue timely alarm information and notify the system unit to handle the rogue ONU device according to the priority processing value and the alarm threshold.

In an embodiment of the disclosure, the device monitoring module 41, the rogue phenomenon detection module 42, the rogue device locating module 43, and the alarm module 44 can be implemented through software, firmware, hardware circuits, or any combination thereof.

In an embodiment of the disclosure, the device monitoring module 41, the rogue phenomenon detection module 42, the rogue device locating module 43, and the alarm module 44 are each implemented using a central processing unit (CPU) or other programmable general-purpose or special-purpose microprocessors. In another embodiment of the disclosure, the device monitoring module 41, the rogue phenomenon detection module 42, the rogue device locating module 43, and the alarm module 44 can also be implemented using the same processor, with different modules loaded. The disclosure is not limited to these implementations.

In an embodiment of the disclosure, the device monitoring module 41, the rogue phenomenon detection module 42, the rogue device locating module 43, and the alarm module 44 are externally connected to each other. For example, the combination of the device monitoring module 41, rogue phenomenon detection module 42, rogue device locating module 43, and alarm module 44 can be connected through wired connections to form the intelligent rogue device monitoring equipment 40. Alternatively, the device monitoring module 41, rogue phenomenon detection module 42, rogue device locating module 43, and alarm module 44 may be integrated and housed within the same enclosure.

In an embodiment of the disclosure, the intelligent rogue device monitoring equipment 40 can be built into the service provider premise device, the network management system, or other externally connected standalone devices. The combination shown in FIG. 3 is merely illustrative and not limiting.

In the following, the method described in this embodiment will be explained with reference to the devices, components, and modules shown in FIGS. 2 and 3. The process steps of this method can be adjusted according to implementation needs and are not limited to the described process.

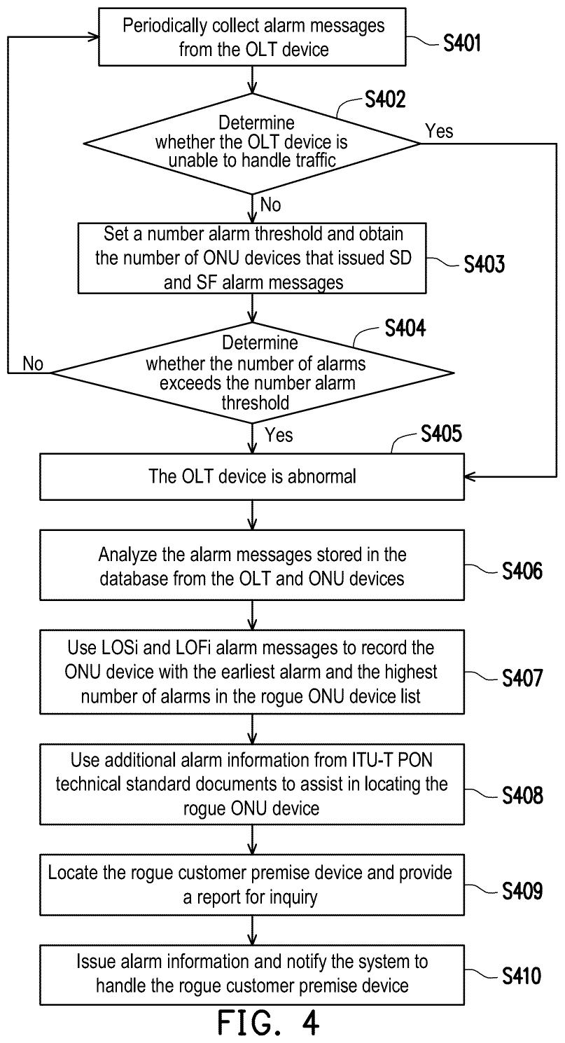

FIG. 4 is a flowchart of the method for intelligently detecting and locating rogue ONU devices according to one embodiment of the disclosure. The method shown in FIG. 4 is at least applicable to the system for intelligently detecting and locating rogue ONU devices as described in the embodiment shown in FIG. 3, but the disclosure is not limited thereto. The following will describe the operation and details of the method for the system for intelligently detecting and locating rogue ONU devices with reference to FIGS. 2 and 3.

Referring to FIG. 4, in step S401, the intelligent rogue device monitoring equipment 40 periodically collects alarm messages from the OLT device 30 according to a preset detection time cycle and stores the alarm messages in the database 50.

The preset detection time cycle is a count of any arbitrary number of seconds. In an embodiment, the preset detection time cycle can be set to one hour. The device monitoring module 41 continuously collects alarm messages from the OLT device 30 and the ONU devices 10 during the detection time cycle and stores the alarm messages in the database 50 according to the schedule. In this way, it avoids the possibility of alarm information being overwritten or lost due to insufficient memory capacity in the OLT device 30.

In step S402, the rogue phenomenon detection module 42 determines whether the OLT device 30 is unable to handle traffic.

In an embodiment, the rogue phenomenon detection module 42 can determine whether the OLT device 30 is unable to handle traffic according to whether there are alarm messages, such as LOS (loss of signal), from the PON port or OLT device 30. If there are alarm messages like LOS, the rogue phenomenon detection module 42 determines that the OLT device 30 is unable to handle traffic and directly identifies the OLT device 30 as an abnormal OLT device or abnormal PON port.

If there is no LOS alarm, the rogue phenomenon detection module 42 determines that the OLT device 30 is capable of processing traffic and counts the alarm messages for SD (signal degraded of ONU) or SF (signal fail of ONU). In step S403, the rogue phenomenon detection module 42 sets a quantity alarm threshold and obtains the number of alarm messages from the ONU devices 10 that issued SD and SF alarms.

In step S404, the rogue phenomenon detection module 42 determines whether the number of alarms exceeds the quantity alarm threshold.

If the number exceeds the quantity alarm threshold, in step S405, the rogue phenomenon detection module 42 determines that the OLT device 30 is abnormal, meaning that rogue phenomena exist under this PON port, and identifies the OLT device 30 as an abnormal OLT device or abnormal PON port, thereby achieving a preemptive malfunction warning.

If the number does not exceed the quantity alarm threshold, the process returns to step S401, where alarm messages continue to be collected periodically.

In an embodiment, the rogue phenomenon detection module 42 can obtain the quantity alarm threshold according to the total number of ONU devices 10 under the same PON port or OLT device 30, using either a selected ratio (e.g., 30% of the total) or a fixed value. The rogue phenomenon detection module 42 counts the number of ONU devices 10 that issue alarm messages SD₍ᵢ₎ and SF₍ᵢ₎, and according to whether this number exceeds the quantity alarm threshold, it determines whether the OLT device 30 is abnormal. In other words, it detects whether rogue phenomena exist under this PON port and obtains the number of the OLT device 30, identifying it as an abnormal OLT device or abnormal PON port, thereby issuing a preemptive malfunction warning.

In step S406, the rogue device locating module 43 analyzes the alarm messages stored in the database 50 from the OLT device 30 and the ONU devices 10.

In step S407, the rogue device locating module 43 uses the alarm messages LOS₍ᵢ₎ and LOF₍ᵢ₎ to record the ONU device with the earliest alarm and the highest number of alarms in the rogue ONU device list.

In an embodiment, the rogue device locating module 43 can identify the ONU device 10 as a rogue ONU device by analyzing the alarm messages LOS₍ᵢ₎ and LOF₍ᵢ₎ collected during the detection time cycle. The ONU device 10 with the earliest alarm occurrence time and the highest number of alarms is identified as the rogue ONU device, and the number i of the ONU device 10 is recorded in the rogue ONU device list.

In step S408, the rogue device locating module 43 can use additional alarm information from ITU-T PON technical standard documents to assist in locating the rogue ONU device.

In an embodiment, the rogue device locating module 43 can assist in locating or identifying the rogue ONU device among the ONU devices 10 by collecting alarm messages such as Dying Gasp, OMCI signaling failures, and connection authentication failures, and counting the ONU device 10 with the highest number of alarms, using the alarm rules as guidance.

In step S409, the rogue device locating module 43 can locate the rogue customer premise device and generate a report for inquiry.

In an embodiment, after locating the rogue ONU device under the PON port, the rogue device locating module 43 can generate a report that records the reasons why the rogue ONU device matches the alarm rules for the user's reference. Additionally, the rogue device locating module 43 can obtain a priority processing value or priority processing percentage for the rogue ONU device according to the weight of the alarm rules and the alarm messages, and store the priority processing value in the database 50.

In step S410, the alarm module 44 issues an alarm message and notifies the system of the rogue customer premise device that needs to be addressed.

In an embodiment, the alarm module 44 can set an alarm threshold and, according to the priority processing value and the alarm threshold, determine whether to issue an alarm message. The alarm is issued in a timely manner to notify the user to handle the rogue ONU device.

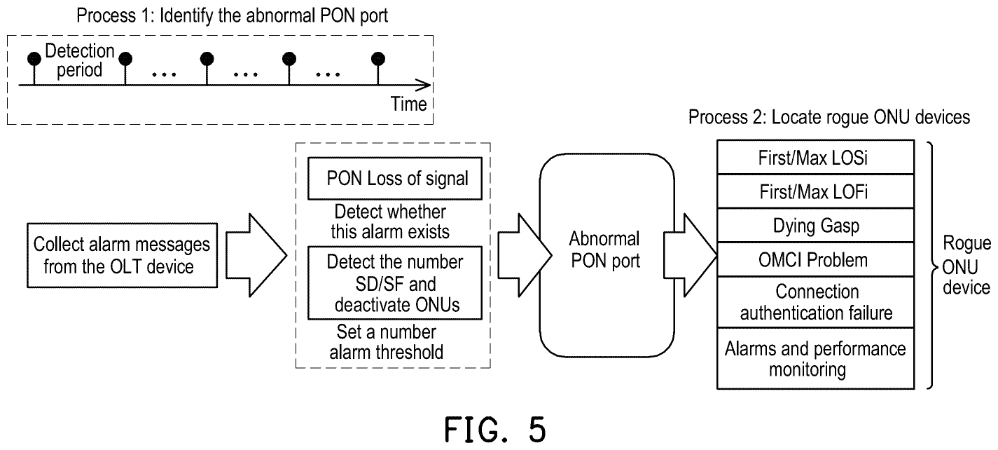

For ease of understanding, the following will describe the details of the operation steps of the method for intelligently detecting and locating rogue ONU devices, using FIG. 5 as a reference.

FIG. 5 is a schematic diagram of the operation of the system for intelligently detecting and locating rogue ONU devices according to one embodiment of the disclosure.

Referring to FIG. 5, in the operating scenario of locating an abnormal PON port (as shown in Flow 1 of FIG. 5), the OLT device 30 and the ONU devices 10 periodically collect alarm messages according to a preset detection time cycle.

If rogue phenomena occur on ONU devices under the same PON port, the rogue ONU device's optical signal emitted at the wrong time will affect other normal ONU devices. This will result in a higher bit error rate for multiple normal ONU devices and cause alarm messages related to signal attenuation. Typically, the quantity alarm threshold can be set at around 30-50% of the total number of ONU devices under the same PON port, or a fixed number according to experience can be used. When the number of ONU devices under the same PON port that are disconnected or affected (i.e., ONU devices issuing SD and SF alarm messages) reaches the quantity alarm threshold, it is determined that rogue phenomena are present in this PON port, and the PON port is classified as an abnormal PON port.

In the scenario of locating a rogue ONU device (as shown in Flow 2 of FIG. 5), when an abnormal PON port is detected, and rogue malfunctions are occurring, they are typically accompanied by the disconnection of several ONU devices and alarm messages such as LOSi and LOFi. At this point, the alarm messages collected during the detection cycle are tallied. Based on the LOSi and LOFi alarm messages, the ONU device that raised the earliest alarm and has the highest number of alarms is identified as the rogue ONU device, and the number i of the ONU device is recorded in the rogue ONU device list.

Furthermore, the causes of rogue malfunctions are numerous, such as hardware component failures that trigger Dying Gasp, delays in OMCI signaling responses, and repeated authentication failures, which can cause the ONU device to emit light at incorrect time slots. This, in turn, leads to abnormal behavior in other ONU devices. Using the alarm rules and alarm messages, information such as First/Max LOSi, First/Max LOFi, Dying Gasp, OMCI Problem, connection authentication failure, and alarms and performance monitoring can be gathered. This helps identify the ONU device with the highest number of alarms, which can further assist in locating or identifying the ONU device as the rogue ONU device, thereby improving the accuracy of rogue ONU device detection.

In an embodiment, after locating the rogue ONU device under the PON port, a report can be generated to record the reasons why the rogue ONU device matches the alarm rules for user reference. The priority processing value corresponding to the rogue ONU device can be obtained according to the weight of each alarm rule and the alarm messages. The rogue ONU device can then be handled according to the priority processing value. Additionally, according to the priority processing value and the alarm threshold, it can be determined whether to issue alarm information, and an alarm can be issued promptly to notify the user to handle the rogue ONU device.

In an embodiment, the alarm rules may include First/Max LOSi, First/Max LOFi, Dying Gasp, OMCI Problem, connection authentication failure, and alarms and performance monitoring. The disclosure is not limited to these rules.

In another embodiment, the user may set First/Max LOSi and First/Max LOFi as the highest-weighted alarm rules according to their needs. Dying Gasp and OMCI Problem may have lower weights, while connection authentication failure and alarms and performance monitoring are assigned the lowest weights.

Based on the above, the disclosure provides a system and method for intelligently detecting and locating rogue ONU devices. It is applicable to ITU-T standard technologies such as GPON, XGSPON, 50GPON, 25G PON MSA, and future higher-speed PON systems. The system has remote network management and monitoring functions, allowing real-time analysis and judgment through background traffic data without affecting normal user network services. It also schedules and stores alarm information to avoid the possibility of overwriting or losing information due to insufficient storage capacity in the OLT device from large volumes of alarm messages. This effectively reduces troubleshooting time and labor costs, further enhancing network service stability.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A system for intelligently detecting and locating a rogue optical network unit device, comprising:
a plurality of optical network unit devices;
an optical line terminal device, distributing a plurality of optical signals to the plurality of optical network unit devices via an optical splitter;
a database; and
an intelligent rogue device monitoring equipment, electrically connected to the optical line terminal device and the database respectively, wherein the intelligent rogue device monitoring equipment periodically collects an alarm message from the optical line terminal device according to a set detection time period, stores the alarm message in the database, determines whether the optical line terminal device is abnormal according to the alarm message, and identifies the rogue optical network unit device among the plurality of optical network unit devices according to the alarm message and an alarm rule.

2. The system according to claim 1, wherein the intelligent rogue device monitoring equipment comprises:
a device monitoring module, electrically connected to the optical line terminal device and the database respectively and used to periodically collect the alarm message from the optical line terminal device according to the detection time period and store the alarm message in the database; and
a rogue phenomenon detection module, electrically connected to the device monitoring module and used to determine whether the optical line terminal device is incapable of handling a traffic according to the alarm message, wherein when the optical line terminal device is incapable of handling the traffic, the optical line terminal device is determined as abnormal, and when the optical line terminal device is not incapable of handling the traffic, whether the optical line terminal device is abnormal is determined according to whether a number of the plurality of optical network unit devices issuing a specific alarm message exceeds a number alarm threshold.

3. The system according to claim 2, wherein the intelligent rogue device monitoring equipment further comprises:
a rogue device locating module, electrically connected to the rogue phenomenon detection module and used to identify the rogue optical network unit device among the plurality of optical network unit devices according to an alarm occurrence time and a number of alarms in the alarm message, and to record the rogue optical network unit device in a rogue optical network unit device list,
wherein the device monitoring module is further used to periodically collect the alarm message from the plurality of optical network unit devices according to the detection time period and store the alarm message in the database, and
the rogue device locating module is further used to identify the rogue optical network unit device among the plurality of optical network unit devices according to the alarm message and the alarm rule.

4. The system according to claim 3, wherein the rogue device locating module is further used to obtain a priority processing value corresponding to the rogue optical network unit device according to a weight of the alarm rule and the alarm message, and to store the priority processing value in the database.

5. The system according to claim 4, wherein the intelligent rogue device monitoring equipment further comprises:
an alarm module, electrically connected to the rogue device locating module and the database respectively, and used to determine whether to issue an alarm information to notify a user to handle the rogue optical network unit device according to the priority processing value and an alarm standard.

6. A method for intelligently detecting and locating a rogue optical network unit device, applied to a system comprising a plurality of optical network unit devices, an optical line terminal device distributing a plurality of optical signals to the plurality of optical network unit devices via an optical splitter, a database, and an intelligent rogue device monitoring equipment electrically connected to the optical line terminal device and the database respectively, the method comprising:
the intelligent rogue device monitoring equipment periodically collecting an alarm message from the optical line terminal device according to a set detection time period, and storing the alarm message in the database;
the intelligent rogue device monitoring equipment determining whether the optical line terminal device is abnormal according to the alarm message; and
the intelligent rogue device monitoring equipment identifying the rogue optical network unit device among the plurality of optical network unit devices according to the alarm message and an alarm rule.

7. The method according to claim 6, wherein the intelligent rogue device monitoring equipment determining whether the optical line terminal device is abnormal according to the alarm message further comprises:
the intelligent rogue device monitoring equipment determining whether the optical line terminal device is incapable of handling a traffic according to the alarm message;
when the optical line terminal device is incapable of handling the traffic, determining the optical line terminal device as abnormal; and
when the optical line terminal device is not incapable of handling the traffic, determining whether the optical line terminal device is abnormal according to whether a number of the plurality of optical network unit devices issuing a specific alarm message exceeds a number alarm threshold.

8. The method according to claim 7, wherein the intelligent rogue device monitoring equipment identifying the rogue optical network unit device among the plurality of optical network unit devices according to the alarm message and the alarm rule further comprises:
the intelligent rogue device monitoring equipment identifying the rogue optical network unit device among the plurality of optical network unit devices according to an alarm occurrence time and a number of alarms in the alarm message, and recording the rogue optical network unit device in a rogue optical network unit device list;
the intelligent rogue device monitoring equipment periodically collecting the alarm message from the plurality of optical network unit devices according to the detection time period, and storing the alarm message in the database; and
the intelligent rogue device monitoring equipment identifying the rogue optical network unit device among the plurality of optical network unit devices according to the alarm message and the alarm rule.

9. The method according to claim 8, wherein the intelligent rogue device monitoring equipment identifying the rogue optical network unit device among the plurality of optical network unit devices according to the alarm message and the alarm rule further comprises:
the intelligent rogue device monitoring equipment obtaining a priority processing value corresponding to the rogue optical network unit device according to a weight of the alarm rule and the alarm message, and to store the priority processing value in the database.

10. The method according to claim 9, wherein the intelligent rogue device monitoring equipment identifying the rogue optical network unit device among the plurality of optical network unit devices according to the alarm message and the alarm rule further comprises:
the intelligent rogue device monitoring equipment determining whether to issue an alarm information to notify a user to handle the rogue optical network unit device according to the priority processing value and an alarm standard.
